(19) United States
(12) Patent Application Publication
(10) Pub. No.: US 2004/0064983 A1
(43) Pub. Date: Apr. 8, 2004

(54) Distribution of promotional indicia on lids, covers or closures

(76) Inventor: Maria Hanna Joseph, Leicester, MA (US)

Correspondence Address: Brian M. Dingman, Mirick, O'Connell, DeMallie & Lougee, LLP, 1700 West Park Drive, Westborough, MA, 01581-3941, US

(21) Appl. No.: 10/676,435

(22) Filed: Oct. 1, 2003

Related U.S. Application Data
(60) Provisional application No. 60/416,648, filed on Oct. 7, 2002.

(51) Int. Cl. G09F 3/00

(52) U.S. Cl. 40/324

(57) ABSTRACT

A lid, cover or closure for cups or containers that holds hot or cold liquids or other substances intended for individual consumer consumption which displays informational, advertising and decorative indicia including images, language, color, symbols, art, and/or print, by means of printing, imprinting, embossing, dying, drawing, adhering, and any and all other means of imposing or incorporating such indicia onto the lid, cover or closure. The lid, cover or closure allows for individualized advertisements, coupons, messages, or other communicating or decorative content that can be permanent or removable. The lid, cover or closure includes advertising, informational or decorative indicia on its top, bottom and/or sides. The present invention provides an improved means for distributing information, advertisements and coupons, as well as enhancing the aesthetics of lids, covers or containers.

### CROSS REFERENCE TO RELATED APPLICATION

This application claims priority of Provisional application serial No. 60/416,648, filed on Oct. 7, 2002.

### FIELD OF THE INVENTION

The present invention relates generally to lids, covers or closures for cups or containers of hot or cold liquids, and other substances for use in displaying advertising, promotion, decoration, imaging, printing, instruction, and information, as well as offering features that make the lid, cover or closure more attractive such as color and texture. The present invention may be commonly referred to as a promotional lid. More specifically, the present invention relates to a lid, cover or closure of a container for hot or cold liquids or other substances that carries promotional, decorative, or other information on its surface(s) to communicate to consumers of the containers' substances.

### BACKGROUND OF THE INVENTION

Containers for beverages, food and other substances intended for consumer purchases are known. Further, it is known that such containers include indicia relating benefits, promotions, and information, as well as decorative imaging.

In general, surface areas of product containers have been given additional purpose and value by their use in displaying such indicia. The surfaces of beverage lids, covers and closures, however, have not been so utilized. Instead, loose materials provided separately from the container, sometimes within it, are used to convey benefits, promotions, etc. This excess material is often overlooked or disregarded, rendering the material as excess and waste. Moreover, the resources, natural and otherwise, that are consumed in manufacturing such material also become wasted.

Information incorporated into or onto the containers themselves minimizes, if not eliminates, the waste of material that never reaches its intended consumer's attention. Empty space on the surfaces of lids, covers and closures offer an untapped source for disseminating the same information and thereby reduces and eliminates the wasting of other material.

By making use of containers' surfaces to display indicia related to promotions, benefits, advertising and other information, as well as decoration, is already popular in wake of the value of directly communicating with consumers. It is the consumers' positive reaction to this means of appealing to them that encourages and perpetuates this kind of use over such surface areas. Despite the value of using container surface area to communicate or display indicia, however, the containers' lids, covers and closures have not been employed or distributed to a significant extent, particularly in relation to the realm of beverage items. If an economical and aesthetically pleasing scheme for distributing promotional or decorative lids, covers or closures of a consumer's beverage purchase could be developed, such a scheme would further advance the use of this popular way of communicating with consumers. Furthermore, by giving an already useful item an additional purpose, it would also conserve resources that are used to create materials that more often create waste, as well as serve a lesser functional purpose.

### SUMMARY OF THE INVENTION

The present invention satisfies the aforenoted need by providing an additional, valuable use to an already functional lid, cover or closure for containers of hot or cold liquids or other substances. The surface areas of these functional items are printed with indicia such as informational indicia, advertising indicia, or decorative indicia, or decorative indicia.

The indicia may be permanently incorporated into or onto the lid, cover or closure, or may be removable at the consumer's discretion. Accordingly, the information is discarded only when the lid's primary use is expired, or when the value of the information has been exhausted by the consumer, in which case, the waste of material is diminished.

Other advantages and objects of the present invention will become apparent upon reading the following detailed description and appended claims.

### BRIEF DESCRIPTION OF THE DRAWINGS

The invention is illustrated more or less diagrammatically in the following drawings wherein:

FIG. 1 is a top perspective view of a lid, cover or closure placed on top of a beverage cup that is known in the art;

FIG. 2 is a view directly above the lid, cover or closure that is known in the art;

FIG. 3 is a side view of the lid, cover or closure atop a beverage cup, seen from an above vantage point in FIG. 1, also known in the art; and FIG. 4 is a side bottom view of the loose lid, cover or closure that is known in the art;

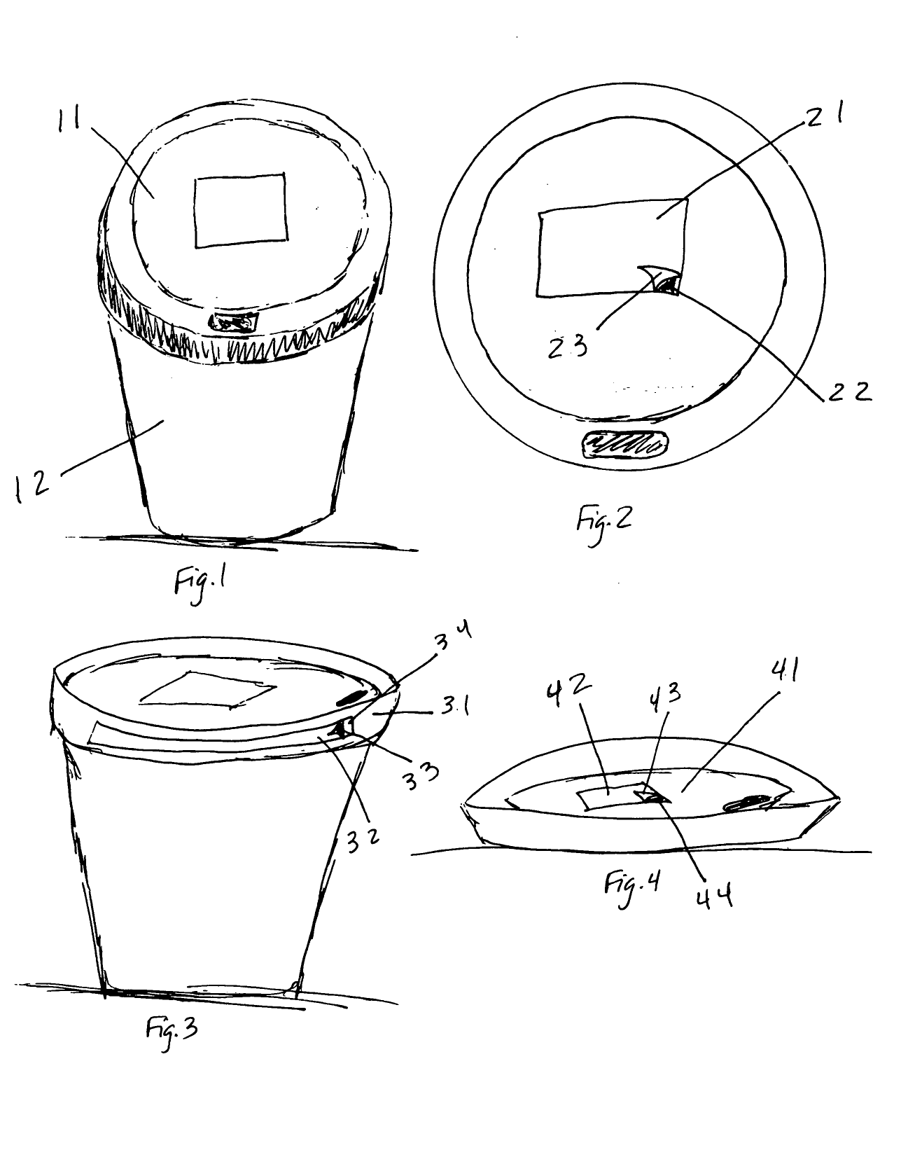

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

### DETAILED DESCRIPTION OF THE PREFERRED EMBODIMENTS

The vehicle for the indicia described hereinabove is a circular lid, cover or closure (sometimes referred to collectively herein as a “lid”) that fits onto the top of a container which holds hot or cold liquids.

The indicia may be attached by glue or adhesive, or it may be otherwise imprinted, onto the surface of the lid, cover or closure.

The circular lid, cover or closure has, in most basic terms, three surface areas: (1) A top surface 11 which covers the top open-mouthed portion of an upright container 12, (2) an obverse or bottom surface 41 which is the underside of the top surface, and (3) the side circumference area 31 which fits over the lip of the upright container and is virtually perpendicular to the top and obverse surfaces.

The indicia 21, 32, 42 to be carried on the lid, cover or closure is to be situated on either or all of these three surface areas. The indicia is visually apparent from any angle or position, and in any manner it is situated, whether the lid, cover or closure is fastened onto a container, held in a consumer's hands, or resting upright, upside down, or on its side. Thus, all sides of the lid, cover or closure are utilized, which may be considered unattractive to both the consumer and the publisher. The indicia, however, need not be carried on all sides or surface areas in order for its utility to be realized.

As an alternative, the indicia may be carried on the lid, cover or closure, but also offer the consumer an opportunity to remove the indicia. For example, a label 21, 32, 42 that is removable or has perforation allowing it to be practically lifted or peeled off of and removed from the surface of the lid (as shown by indication of removability at 23, 33 and 43, respectively). There may also be included under a removable layer, an underlying layer 22, 34 and 44, respectively, with additional indicia. This allows for greater utility in that even more information may be carried.

The indicia will be incorporated onto the structural surface(s) of the lid, cover or closure, or it may be located in a certain area thereon, or in a particular shape and size conducive to the shape, size and surface area of the lid, cover or closure on which it is may be placed, or it will be on material, such as paper or adhesive, that is likewise fitting for the lid, cover or closure on which it is may be placed.

Suitable plastic and print material for use with the present invention is readily available and suppliers will be known to those skilled in the art.

The manner of producing, manufacturing, printing, dying or otherwise imparting the indicia to the lid may be effected prior to the completion of the manufacturing of the finished lid, it may take place during the lid's manufacturing, or it may take place after the completion of the lid's manufacturing.

From the above description, it is apparent that the advantages and objects of the present invention have been achieved. While only certain embodiments have been set forth, alternative embodiments and various modifications will be apparent from the above description to those skilled in the art. In disclosing these preferred embodiments for the lid, changes and modifications can be made without departing from the spirit of the invention.

What is claimed is:

1. A method of providing permanent or removable indicia comprising information, advertisements, decoration, and/or coupons on the top, bottom and/or side surfaces of lids for cups or containers that hold hot or cold liquids or other substances intended for individual consumer consumption in the spirit of and for purposes of serving as a medium for carrying advertising, promotion, decoration, imaging, printing, instruction, and information, as well as features that make the lid, cover or closure more aesthetically attractive such as color and texture, the method comprising the following steps:
providing a lid for a cup or container that holds hot or cold liquids, the lid defining top, side and bottom surfaces; and
placing indicia on at least one surface of the lid.

2. The method of claim 1 wherein the lid is made of any material conducive to and appropriate for containing hot or cold liquids, or other substances.

3. The method of claim 1 wherein the indicia is placed onto the lid by any method available including, but not limited to, methods of printing, dying, drawing, embossing, imprinting, and/or by way of adhering substances such as paper onto them.

4. The method of claim 1 wherein the indicia is of any size or dimension necessary to fit or accommodate any and all sizes and styles of lids.

5. The method of claim 1 wherein the indicia is displayed permanently on the lid.

6. The method of claim 1 wherein the indicia is displayed temporarily on the lid.

7. The method of claim 1 wherein the indicia is placed directly on the lid.

8. The method of claim 1 wherein the indicia is placed indirectly on the lid.

9. The method of claim 8 wherein the indirect placement is accomplished by placing the indicia on a member that is removably coupled to the lid.

10. The method of claim 9 wherein the removable coupling is accomplished with a peel-off sticker.

11. The method of claim 9 wherein the removable coupling is accomplished with a perforated, tear-off member.
